(19) United States
(12) Patent Application Publication
(10) Pub. No.: US 2026/0100759 A1
(43) Pub. Date: Apr. 9, 2026

(54) GROUND POINT-TO-POINT OPTICAL COMMUNICATION SYSTEM

(71) Applicant: Xenesis Global Inc., Lisle, IL (US)

(72) Inventor: Jeffrey Palmer Cole, Shoreview, MN (US)

(73) Assignee: Xenesis Global Inc., Lisle, IL (US)

(21) Appl. No.: 19/347,105

(22) Filed: Oct. 1, 2025

Related U.S. Application Data
(60) Provisional application No. 63/703,380, filed on Oct. 4, 2024.

(51) Int. Cl. H04B 10/118; H04B 10/27; H04L 45/00; H04L 61/2592

(52) U.S. Cl. CPC H04B 10/118; H04B 10/27; H04L 45/20; H04L 61/2592

(57) ABSTRACT

Methods are described herein for receiving, at a terrestrial hub, a data packet. The terrestrial hub may be associated with one or more locations. The terrestrial hub may identify a destination associated with the data packet by decapsulating the data packet. The method may further include verifying that the destination associated with the data packet is a location of the one or more locations and determining a next-hop destination for the data packet based on the identified destination. The terrestrial hub may encapsulate the data packet with a header that includes an address for the next-hop destination and transmit the encapsulated packet.

### CROSS-REFERENCE TO RELATED APPLICATIONS

This application claims benefit of priority to U.S. Provisional Patent Application No. 63/703,380, filed October 4, 2024, entitled “GROUND POINT-TO-POINT OPTICAL COMMUNICATION SYSTEM,” and is related to U.S. Patent Application No. 18/376,623, filed October 4, 2023, entitled “GEO-POSITION BASED NETWORK ROUTING PROTOCOL,” which are incorporated by reference herein in their entirety and for all purposes.

### TECHNICAL FIELD

This disclosure relates generally to communication networks, and more specifically, to free-space optical transmission in communication networks.

### BACKGROUND

Optical data transmission involves the use of light-based communication, typically via lasers, to transmit data between satellites or between satellites and ground stations. This method enables high-speed, long-distance data transfer by utilizing free-space optics, which offers advantages over traditional radio frequency (RF) communications, such as increased bandwidth, reduced latency, and improved security. In satellite networks, especially Low Earth Orbit (LEO) constellations, optical transmission supports the efficient relaying of data across the globe, enabling robust, low-latency connections for various applications, including broadband internet and global communications. However, optical data transmission is not available in areas where the terrain will not accommodate light-based communication, such as in mountainous and rural environments.

### SUMMARY

Methods are described herein for transmitting data packets over hybrid networks. A terrestrial hub may be associated with one or more locations. The terrestrial hub may identify a destination associated with the data packet, and the destination may be identified by decapsulating the data packet. The method may further include verifying that the destination associated with the data packet is a location of the one or more locations and determining a next-hop destination for the data packet based on the identified destination. The terrestrial hub may encapsulate the data packet with a header that includes an address for the next-hop destination and transmit the encapsulated packet.

Systems are described herein for free-space optical transmission. The systems may comprise one or more processors and a memory storing instructions that, as a result of being executed by the one or more processors, cause the system to perform any of the aforementioned methods.

Non-transitory computer-readable storage media are described herein that store instructions therein that, as a result of being executed by one or more processors, cause the one or more processors to perform the any of the aforementioned methods.

Various examples of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an example in the present disclosure can be references to the same example or any example; and such references mean at least one of the examples.

Reference to “one example” or “an example” means that a particular feature, structure, or characteristic described in connection with the example is included in at least one example of the disclosure. The appearances of the phrase “in one example” in various places in the specification are not necessarily all referring to the same example, nor are separate or alternative examples mutually exclusive of other examples. Moreover, various features are described which can be exhibited by some examples and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various examples given in this specification.

Without intent to limit the scope of the disclosure, examples of instruments, apparatus, methods, and their related results according to the examples of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

### BRIEF DESCRIPTION OF THE DRAWINGS

To easily identify the discussion of any particular element or act, the most significant digit or digits in a reference number refer to the figure number in which that element is first introduced.

FIG. 1 illustrates a block diagram of an example system for free-space optical transmission on a communication network according to some aspects of the present disclosure.

FIG. 2 illustrates an example implementation of a system for free-space optical transmission within a communication network according to some aspects of the present disclosure.

FIG. 3 illustrates a flowchart of an example process for free-space optical transmission data received from a remote network according to some aspects of the present disclosure.

FIG. 4 illustrates a flowchart of an example process for free-space optical transmission data received from a ground station according to some aspects of the present disclosure.

FIG. 5 illustrates an example computing device capable of executing free-space optical transmission according to some aspects of the present disclosure.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

In the following description, for the purposes of explanation, specific details are set forth in order to provide a thorough understanding of certain inventive examples. However, it will be apparent that various examples may be practiced without these specific details. The figures and description are not intended to be restrictive. The word “exemplary” is used herein to mean “serving as an example, instance, or illustration.” Any example or design described herein as “exemplary” is not necessarily to be construed as preferred or advantageous over other examples or designs.

Free Space Optical Transmission refers to the communication of data through the atmosphere or vacuum using light, typically through laser or infrared beams. Free space optical transmission allows for high-speed, point-to-point data transfer between two locations without the need for physical infrastructure such as fiber-optic cables. This is accomplished through the use of laser beams or other focused light sources, allowing for highly directed, high-bandwidth communication. Unlike traditional radio frequency (RF) systems, optical transmission operates at significantly higher frequencies, allowing for greater data throughput and higher spectral efficiency. Free space optical transmission systems may use transmitters, which encode data onto light waves using modulation techniques, and photodetectors, which capture the light and convert it back into electrical signals at the receiver. Optical links can be established between satellites, between satellites and ground stations, or between terrestrial endpoints, enabling efficient Layer 2 and Layer 3 communications.

The free space optical transmission described herein achieves extremely narrow beam divergence, meaning that more data can be transmitted with less interference from nearby communication links. However, this also introduces challenges, as the system must be highly precise in maintaining alignment between the transmitter and receiver. Atmospheric conditions, such as turbulence, cloud cover, and rain, can affect transmission quality, so adaptive optics and beam steering technologies are often used to compensate for environmental factors. Line-of-sight communication is critical for maintaining a stable link, particularly in satellite applications, where small angular adjustments are made to ensure continuous communication across varying orbital paths. In some environments, the adaptive optics and beam steering necessary to achieve effective communication would be next to impossible due to natural barriers, such as mountains, dense foliage, rocky landscapes, unpredictable weather patterns, any combination thereof, or the like. In these rural areas, it would also be impracticable to rely on the installation of fiber optic cables for data transmission.

To achieve effective and efficient data transmission, a hybrid network may be defined including one or more satellites or satellite constellations and one or more terrestrial hubs configured to forward data packets to one or more ground stations associated with an endpoint (e.g., a ground station, a satellite, etc.). Thus, in situations where it would be increasingly difficult to transmit data packets via low Earth orbit (LEO) satellites, a terrestrial hub may be incorporated into the communication path to forward communications to a recipient ground station or endpoint. The hybrid network can replace the requirements for elaborate infrastructure for data transfer (e.g., a large network of fiber-optic cables) to difficult to access environments (e.g., such as rural environments, mountainous environments, etc.) and allows for quick and convenient implementation. For example, an edge device (e.g., a LEO satellite, an undersea fiber-optic cable associated with a communication network, etc.) may receive a data packet with a destination Internet Protocol (IP) address that is associated with a remote endpoint. The edge device may forward the data packet to a terrestrial hub associated with the remote endpoint (e.g., via a fiber optic cable, free space optical transmission, RF transmission, etc.). The terrestrial hub may receive the data packet, obtain the destination IP address, and forward the data packet to the corresponding remote endpoint.

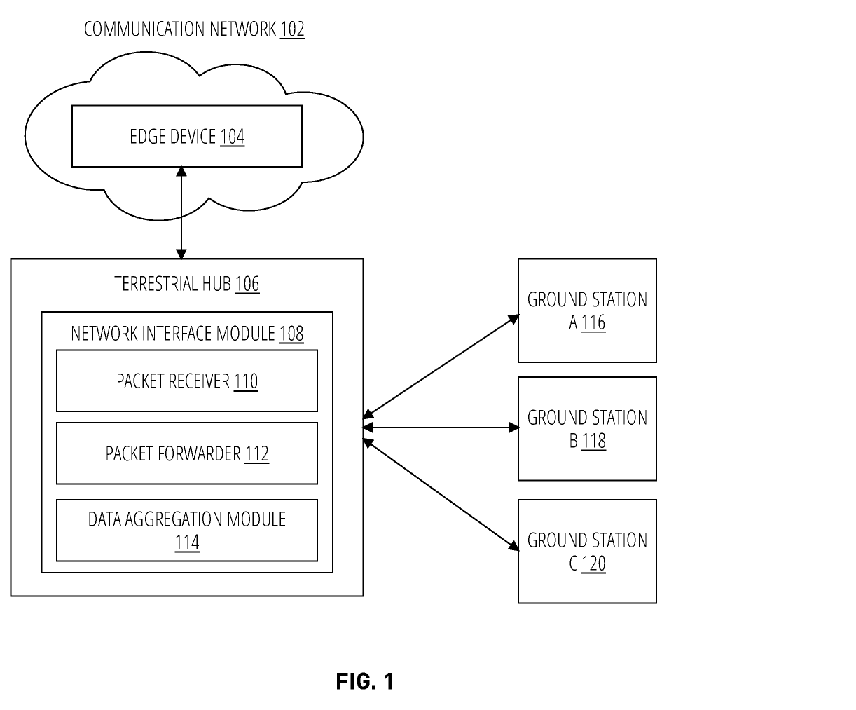

FIG. 1 illustrates a block diagram of an example system for free-space optical transmission on a communication network according to some aspects of the present disclosure. Communication network 102 may facilitate communications between edge device 104, terrestrial hub 106, and/or ground stations (e.g., ground station A 116, ground station B 118, and/or ground station C 120). The devices (e.g., edge device 104, terrestrial hub 106, and/or ground stations) associated with communication network 102 may be interconnected network nodes participating in communication network 102 as data sources, data destinations, and/or intermediary nodes propagating data from the sources to the destinations through communication network 102. The devices associated with communication network 102 may be operated as switches, routers, and/or gateways. Communication network 102 may be operated by a central controller that may manage the devices associated with communication network 102.

Communication network 102 may allow for interactions between the devices associated with communication network 102, such as conveying information between computing devices. Communication network 102 may be public, private, or a combination of public and private and/or be composed of one or more sub-networks or autonomous networks. Communication network 102 can be any type and/or form of data network and/or communication network involving the deployment of network devices in orbit, such as a wide area network (WAN). For example, communication network 102 can be an SD-WAN and edge device 104 may be a low Earth orbit (LEO) satellite configured to transmit data to terrestrial hub 106. In some other examples, edge device 104 may be an Internet trunk that serves as a high-capacity communication link that connects major network nodes or data centers.

Communication network 102 may be associated with one or more edge devices in addition to edge device 104, including any combination of LEO satellites, fiber optic cables (e.g., Internet trunks), terrestrial hubs, ground stations, any combination thereof, or the like. In some examples, edge device 104 may be an instance of a terrestrial hub, distinct from terrestrial hub 106, that is associated with communication network 102. In yet another example, edge device 104 may be a ground station (e.g., such as ground station A 116, ground station B 118, and/or ground station C 120) transmitting a communication through communication network 102.

Edge device 104 may receive a communication from a source (e.g., another edge device, a terrestrial hub, a remote device associated with a second network, any combination thereof, or the like). In some examples, the communication may be transmitted as a frame over a Layer 2 protocol (e.g., multi-protocol label switching (MPLS)), as a data packet over a Layer 3 protocol (e.g., Internet Protocol (IP) routing), any combination thereof, or the like. The communication may include a source identifier (ID) and a destination ID. The source ID and/or the destination ID may be an IP address, a label, a MAC address, any combination thereof, or the like. In some examples, edge device 104 may demodulate and/or decapsulate the communication to determine the destination ID. Based on the destination ID, edge device 104 may determine a terrestrial hub (e.g., terrestrial hub 106) appropriate to forward the communication. This determination may be based on a geo-location associated with one or more terrestrial hubs associated with communication network 102, and/or may be based on an association between a terrestrial hub and a particular ground station (e.g., the destination ID may be associated with a ground station that is reachable by a particular terrestrial hub). For further details on geo-position-based routing, reference is made to U.S. Patent Application No. 18/376,623, filed October 4, 2023, entitled “GEO-POSITION BASED NETWORK ROUTING PROTOCOL,” which is incorporated by reference herein in its entirety for all purposes. In some examples, a reference table (e.g., a routing and/or forwarding table) may be stored in a location accessible by edge device 104 that has stored one or more terrestrial hubs in association with one or more ground stations, where an association indicates reachability. For example, terrestrial hub 106 may be stored in association with ground station A 116, which indicates that ground station A 116 may be reachable by terrestrial hub 106.

Edge device 104 may modulate and/or encapsulate the destination ID and/or any data included in the communication and may transmit the communication to terrestrial hub 106. The destination ID may be encapsulated in a header of the communication (e.g., a data packet header). The communication may be transmitted wirelessly (e.g., through free-space optical transmission, RF transmission, etc.) or via one or more fiber optic cables associated with communication network 102 (e.g., originating from an Internet trunk, such as an undersea cable associated with communication network 102).

The communication may be received at network interface module 108. Network interface module 108 may include a network interface driver and/or a network interface card. The network interface driver may include a software module running on an operating system (e.g., implemented as logic in a hardware processor or other integrated circuit or as a combination of hardware and software logic), while the network interface card may be a physical hardware device that may allow terrestrial hub 106 to connect to communication network 102. The network interface driver and the network interface card may work separately or in conjunction to enable the functionality of network interface module 108. Network interface module 108 may be in communication with packet receiver 110 and/or packet forwarder 112 directly. In some examples, network interface module 108 can be included within a network layer of a network stack of the operating system. For example, the network interface driver can be included within a data link layer of a network stack and can communicate with a software module or application that is included in an application layer of the network stack. As another example, network interface module 108 can be included within a link layer of a network stack and can communicate with a transmission control protocol/Internet protocol (TCP/IP) module that is included in a transport layer of the network stack. As another example, functionality occurring within the network layer of the network stack can additionally or alternatively be configured to receive packets from another network or transport layer protocol module. Network interface module 108 can be configured to transfer data packets over a network protocol (e.g., MPLS) and/or a geo-positional, dynamic label switch routing protocol that incorporates real-time geo-positioning data with MPLS.

Network interface module 108 may forward the communication to packet receiver 110. Packet receiver 110 and/or packet forwarder 112 can be implemented as one or more computer programs, specially configured electronic circuitry, any combination thereof, or the like. Packet receiver 110 can be configured to receive and process data packets from the edge device 104 or other network devices. For example, packet receiver 110 can receive a data packet from edge device 104 and decapsulate the data packet for further processing by data aggregation module 114 and/or packet forwarder 112. Packet forwarder 112 can be configured to process and transmit data packets to ground stations (e.g., ground station A 116, ground station B 118, and/or ground station C 120) of the communication network 102. This may include encapsulating the communication with a header comprising an address for the next-hop destination, which may include a ground station associated with terrestrial hub 106. While shown as separate elements, packet receiver 110 and/or packet forwarder 112 can be part of the same engine and/or module in network interface module 108. Although not shown, network interface module 108 may include one or more processors and memory, which may store the modules and/or engines and the processor(s) may execute the modules and/or engines.

In some examples, network interface module 108 may be in communication with data aggregation module 114. Data aggregation module 114 may serve as an optical network aggregator to combine multiple lower-speed data streams into a single, high-capacity optical signal for more efficient transmission across free-space optical transmission networks, improving bandwidth utilization and network performance. The single, high-capacity optical signal may be transmitted in the form of a “feed.” In some examples, data aggregation module 114 may utilize multiple N+1 feeds, which may refer to using “N” active data feeds (e.g., “N” being a whole number greater than zero) with an additional +1 feed as a backup, ensuring redundancy and seamless failover in case of link failure. These approaches may optimize the reliability, scalability, and efficiency of free-space optical transmission networks, such as communication network 102. In some examples, “N” feeds may be actively transmitted by terrestrial hub 106. In some examples, an additional “+1” feed may be maintained as a reserve and/or backup. This “+1” feed is either idle or used for lower priority traffic but is capable of quickly taking over for any of the active “N” feeds in case of failure or interruption. If one of the “N” feeds is disrupted (e.g., due to atmospheric interference, landscape interference, or hardware failure), the “+1” backup feed immediately takes over the traffic from the failed feed, ensuring seamless communication without data loss. In some examples, data aggregation module 114 may be configured as a feed splitter. For example, data aggregation module 114 may receive a single, high-capacity optical signal, and data aggregation module may split the single, high-capacity optical signal into one or more discrete optical signals.

In some examples, packet receiver 110 may forward one or more lower-speed data streams to data aggregation module 114. The lower-speed data streams may include the communication received from edge device 104. The lower-speed data streams may be received from edge device 104, another network device, an Internet trunk, an undersea cable, a ground station, any combination thereof, or the like. The lower-speed data streams may represent a distinct communication feed that may be transmitted through communication network 102. Data aggregation module 114 may aggregate the lower-speed data streams into a single, high-capacity data stream that may include the communication received from edge device 104. The aggregation process may include synchronizing, compressing, modifying, manipulating, formatting, any combination thereof, or the like, the lower-speed data streams. Data aggregation module 114 may transmit the high-capacity data stream to packet forwarder 112, which may initiate transmission of the high-capacity data stream (e.g., modulate the high-capacity data stream onto a laser beam). In some examples, the destination of the lower-speed data streams may be associated with the same ground station (e.g., ground station A 116). Thus, the high-capacity data stream may be received by ground station A 116.

Ground station A 116 may receive the communication via the high-capacity data stream from terrestrial hub 106. In some examples, ground station A 116 may be equipped with a similar data aggregation module 114, which may de-aggregate the high-capacity data stream, de-modulate the optical signals, and convert the optical signals back to electrical signals (e.g., the communication). In some examples, the destination ID associated with the communication may not be associated with ground station A 116. In some examples, ground station A 116 may serve as an intermediary node on communication network 102 and may forward the communication to a second destination and/or a final destination (e.g., a data center, a computing device, another ground station (e.g., ground station B 118), a router, a server, any combination thereof, or the like).

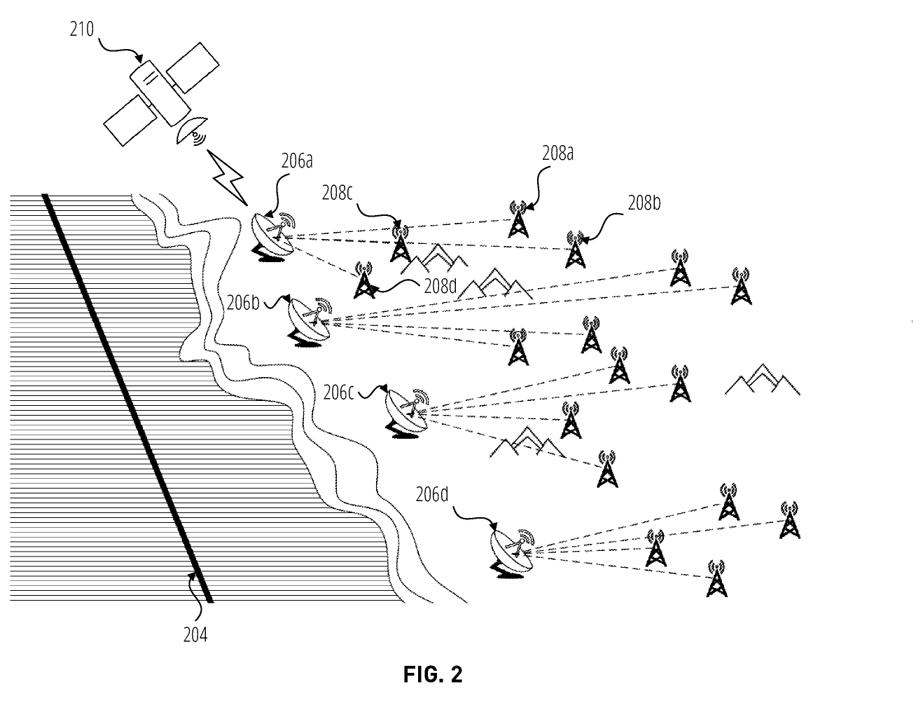

FIG. 2 illustrates an example implementation of a system for free-space optical transmission within a communication network according to some aspects of the present disclosure. Satellite 210 and undersea cable 204 may transmit one or more communications to terrestrial hub 206a, terrestrial hub 206b, terrestrial hub 206c, and/or terrestrial hub 206d. The terrestrial hubs may be associated with one or more ground stations. The one or more ground stations may be strategically stationed at points in the terrestrial environment, such as in a village, at a data center, in a valley, in a mountainous region, any combination thereof, or the like. The ground stations may be a computing device, a router, gateway, switch, a server, a receiver, a transceiver, any combination thereof, or the like. The ground stations may be associated with a facility (e.g., such as, but not limited to, a data center, a residence (e.g., a house, an apartment building, a condominium, etc.), a business, an office building, and/or the like) or a set of set of facilities (e.g., such as, but not limited to, two or more facilities, a regional area, a town, any combination thereof, or the like). For example, terrestrial hub 206a may be associated with ground station 208a, ground station 208b, ground station 208c, and/or ground station 208d, which may be positioned in varying locations in a terrestrial environment.

Traditional means of data transfer (e.g., fiber optic cable communications, RF transmission, free-space optical transmission via satellite, etc.) may be increasingly difficult due to natural barriers, such as mountains, dense foliage, rocky landscapes, unpredictable weather patterns, any combination thereof, or the like. In these rural areas, it would also be impracticable to rely on the installation of fiber optic cables for data transmission. A hybrid network (e.g., a combination of satellite and terrestrial communication methods), as is illustrated in FIG. 2, may enable high-throughput data transmissions to remote environments that are difficult to reach via conventional technologies. The terrestrial hubs may process the one or more communications, then forward the communications to an appropriate ground station. For example, terrestrial hub 206a may forward a communication to ground station 208a. In some examples, ground station 208a may be a final destination associated with a destination ID of the communication. In some other examples, ground station 208a may forward the communication to another hop (e.g., a data center, a computing device, another ground station, a router, a server, any combination thereof, or the like).

In some examples, the ground stations may transmit return communications via the communication network. For example, ground station 208a may transmit a communication to terrestrial hub 206a, which may then be forwarded to satellite 210 and/or undersea cable 204, depending on a return destination ID associated with the return communication.

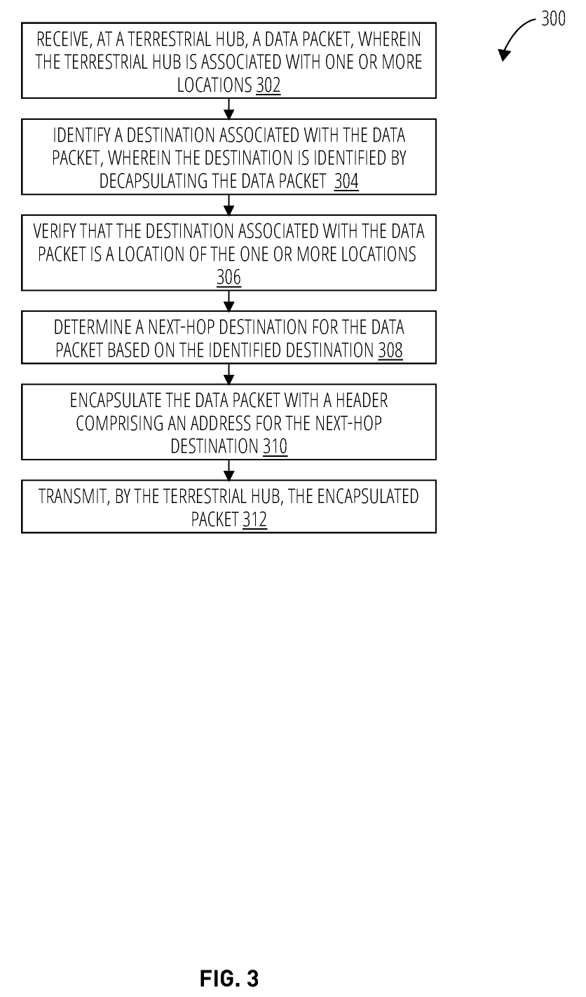

FIG. 3 illustrates a flowchart of an example process for free-space optical transmission data received from a remote network according to some aspects of the present disclosure. Although the example method 300 depicts a particular sequence of operations, the sequence may be altered without departing from the scope of the present disclosure. For example, some of the operations depicted may be performed in parallel or in a different sequence that does not materially affect the function of the method 300. In other examples, different components of an example device or system that implements the method 300 may perform functions at substantially the same time or in a specific sequence.

In block 302, a terrestrial hub receives a data packet, wherein the terrestrial hub is associated with one or more locations. The data packet may be received from an edge device associated with a network, which may include a low Earth orbit (LEO) satellite, an Internet trunk, an undersea cable, a second terrestrial hub, a ground station, any combination thereof, or the like. In some examples, the terrestrial hub may be associated with one or more ground stations at the one or more locations (e.g., each location may be associated with a ground station).

In block 304, the terrestrial hub identifies a destination associated with the data packet, wherein the destination is identified by decapsulating the data packet. The terrestrial hub may decapsulate the data packet to determine a destination ID associated with the data packet. The destination ID may be encapsulated in a header associated with the data packet using an encapsulation method, including, but not limited to, Ethernet, Internet Protocol, multi-protocol label switching (MPLS), transmission control protocol, user datagram protocol, VLAN tagging, generic routing encapsulation, IPsec, optical transport network, any combination thereof, or the like.

In block 306, the terrestrial hub verifies that the destination associated with the data packet is a location of the one or more locations. The one or more locations associated with the terrestrial hub may be “known” (e.g., stored in a routing table, local memory, a cache, etc.). In such an instance, the terrestrial hub may confirm that the destination ID references one of the known one or more locations by comparing the destination ID to the known one or more locations.

In some examples, the terrestrial hub may reference one or more routing and/or forwarding tables stored in a location accessible to the terrestrial hub (e.g., stored locally, on a central server, on a cloud server, any combination thereof, or the like). The one or more routing and/or forwarding tables may include one or more terrestrial hubs stored in association with one or more respective locations, including the current terrestrial hub. In some examples, the one or more routing and/or forwarding tables may include data pertaining to identifiers, routes, geographic location, hardware/software health status, speed, any combination thereof, or the like, associated with the one or more terrestrial hubs and/or the one or more respective locations. The terrestrial hub may, using one or more identifiers associated with the one or more locations (e.g., IP address, tunnel, label, any combination thereof, or the like), verify that the destination ID references at least one of the one or more identifiers associated with the one or more locations. If the destination ID does not reference a location associated with the terrestrial hub, then the terrestrial hub may forward the data packet to an appropriate terrestrial hub or may re-route the data packet back to the source (e.g., an edge device, a LEO satellite, an undersea cable, an Internet trunk, etc.).

In block 308, the terrestrial hub determines a next-hop destination for the data packet based on the identified destination. Using the routing and/or forwarding tables, the terrestrial hub may identify a route to reach a destination associated with the destination ID. In some examples, this may include an intermediary hope between the terrestrial hub and the destination. In some other examples, the terrestrial hub may identify a direct path to the destination.

In block 310, the terrestrial hub encapsulates the data packet with a header comprising an address for the next-hop destination. The data packet may be encapsulated using Ethernet, Internet Protocol, multi-protocol label switching (MPLS), transmission control protocol, user datagram protocol, VLAN tagging, generic routing encapsulation, IPsec, optical transport network, any combination thereof, or the like.

In block 312, the terrestrial hub transmits the encapsulated packet. The terrestrial hub may transmit the encapsulated packet to the destination or to an intermediary hop on a route to the destination. In some examples, the encapsulated packet may be aggregated with one or more additional data packets at the terrestrial hub.

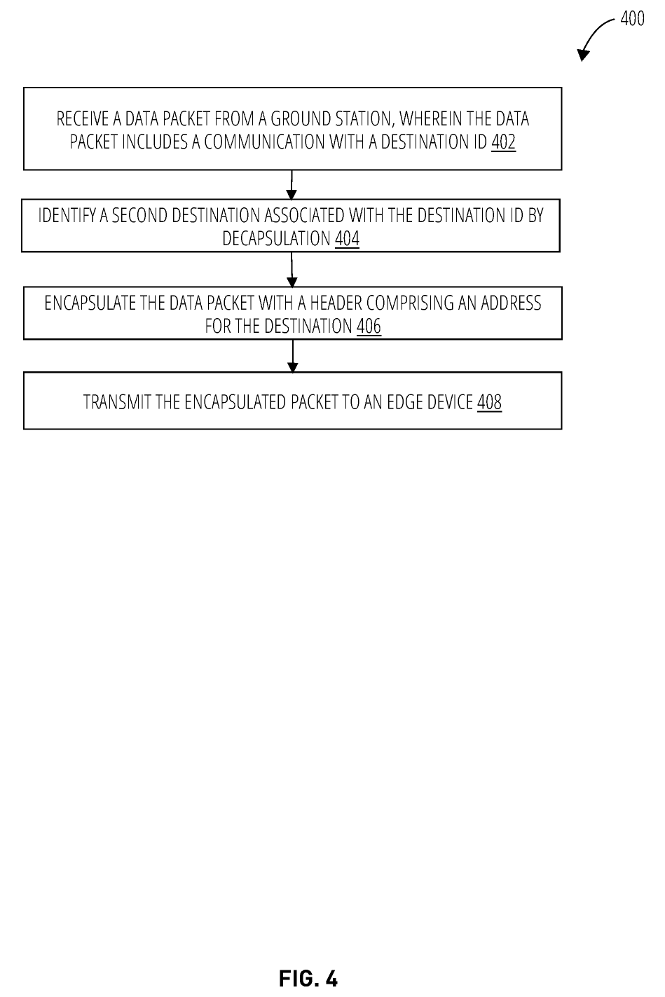

FIG. 4 illustrates a flowchart of an example process for free-space optical transmission data received from a ground station according to some aspects of the present disclosure. Although the example method 400 depicts a particular sequence of operations, the sequence may be altered without departing from the scope of the present disclosure. For example, some of the operations depicted may be performed in parallel or in a different sequence that does not materially affect the function of the method 400. In other examples, different components of an example device or system that implements the method 400 may perform functions at substantially the same time or in a specific sequence.

In block 402, a terrestrial hub receives a data packet from a ground station, wherein the data packet includes a communication with a destination ID. In some examples, the data packet may be encapsulated using Ethernet, Internet Protocol, multi-protocol label switching (MPLS), transmission control protocol, user datagram protocol, VLAN tagging, generic routing encapsulation, IPsec, optical transport network, any combination thereof, or the like. The encapsulation may include data including the destination ID, a source ID, any combination thereof, or the like. In some instances, the data packet may be a return data packet received in response to a previous data packet transmitted by the terrestrial hub to the ground station (or another ground station).

In block 404, the terrestrial hub identifies a second destination associated with the destination ID by decapsulation. The terrestrial hub may decapsulate the data packet and identify the second destination. In some examples, the terrestrial hub may also identify a route for the data packet, which may include a next-hop destination associated with the data packet. In block 406, method 400 encapsulates, at the terrestrial hub, the data packet with a header comprising an address for the destination. The address for the destination may be identified based on one or more routing and/or forwarding tables accessible to the terrestrial hub (e.g., stored locally, on a central server, on a cloud server, any combination thereof, or the like).

In block 408, method 400 transmits, at the terrestrial hub, the encapsulated packet to an edge device (e.g., LEO satellite or internet trunk). In some examples, the terrestrial hub may transmit the encapsulated packet to a second terrestrial hub, a second ground station, or another location reachable by the terrestrial hub. The encapsulated packet may be transmitted by free-space optical transmission to one or more remote networks via one or more satellites, network nodes, ground stations, and/or the like. Alternatively, the encapsulated packet may be transmitted via a cable such as a cable connecting terrestrial hub to the Internet or other network (e.g., such an undersea cable, etc.).

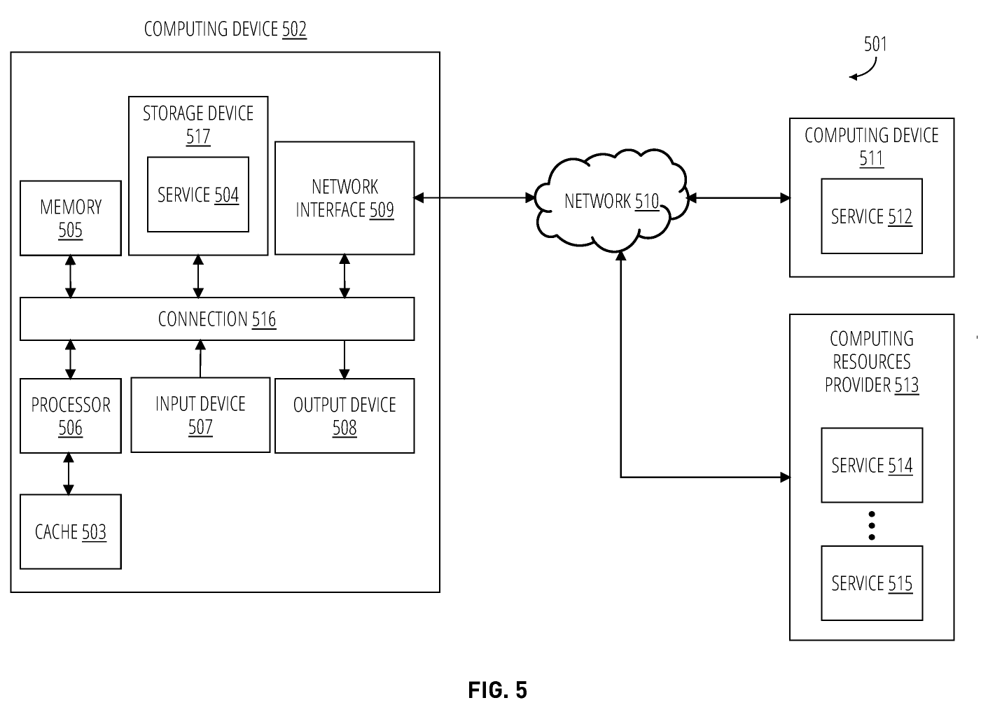

FIG. 5 illustrates an example computing device capable of executing the terrestrial hub and any other associated components according to some aspects of the present disclosure. This may include a computing system architecture 501, including various components in electrical communication with each other. The example computing system architecture 501 illustrated in FIG. 5 includes a computing device 502, which has various components in electrical communication with each other using a connection 516, such as a bus, in accordance with some implementations. The example computing system architecture 501 includes a processor 506 that is in electrical communication with various system components, using the connection 516, and including the system memory 505. In some examples, the system memory 505 includes read-only memory (ROM), random-access memory (RAM), and other such memory technologies including, but not limited to, those described herein. In some examples, the example computing system architecture 501 includes a cache 503 of high-speed memory connected directly with, in close proximity to, or integrated as part of the processor 506. The system architecture 501 can copy data from the memory 505 and/or the storage device 517 to the cache 503 for quick access by the processor 506. In this way, the cache 503 can provide a performance boost that decreases or eliminates processor delays in the processor 506 due to waiting for data. Using modules, methods, and services such as those described herein, the processor 506 can be configured to perform various actions. In some examples, the cache 503 may include multiple types of cache including, for example, level one (L1) and level two (L2) cache. The memory 505 may be referred to herein as system memory or computer system memory. The memory 505 may include, at various times, elements of an operating system, one or more applications, data associated with the operating system or the one or more applications, or other such data associated with the computing device 502.

Other system memory 505 can be available for use as well. The memory 505 can include multiple different types of memory with different performance characteristics. The processor 506 can include any general-purpose processor and one or more hardware or software services, such as service 504 stored in storage device 517, configured to control the processor 506 as well as a special-purpose processor where software instructions are incorporated into the actual processor design. The processor 506 can be a completely self-contained computing system, containing multiple cores or processors, connectors (e.g., buses), memory, memory controllers, caches, etc. In some examples, such a self-contained computing system with multiple cores is symmetric. In some examples, such a self-contained computing system with multiple cores is asymmetric. In some examples, the processor 506 can be a microprocessor, a microcontroller, a digital signal processor (“DSP”), or a combination of these and/or other types of processors. In some examples, the processor 506 can include multiple elements such as a core, one or more registers, and one or more processing units such as an arithmetic logic unit (ALU), a floating point unit (FPU), a graphics processing unit (GPU), a physics processing unit (PPU), a digital system processing (DSP) unit, or combinations of these and/or other such processing units.

To enable user interaction with the computing system architecture 501, an input device 616 can represent any number of input mechanisms, such as a microphone for speech, a touch-sensitive screen for gesture or graphical input, keyboard, mouse, motion input, pen, and other such input devices. An output device 508 can also be one or more of a number of output mechanisms known to those of skill in the art including, but not limited to, monitors, speakers, printers, haptic devices, and other such output devices. In some instances, multimodal systems can enable a user to provide multiple types of input to communicate with the computing system architecture 501. In some examples, the input device 507 and/or the output device 508 can be coupled to the computing device 502 using a remote connection device such as, for example, a communication interface such as the network interface 509 described herein. In such examples, the communication interface can govern and manage the input and output received from the attached input device 507 and/or output device 508. As may be contemplated, there is no restriction on operating on any particular hardware arrangement and accordingly the basic features here may easily be substituted for other hardware, software, or firmware arrangements as they are developed.

In some examples, the storage device 517 can be described as non-volatile storage or non-volatile memory. Such non-volatile memory or non-volatile storage can be a hard disk or other types of computer readable media which can store data that are accessible by a computer, such as magnetic cassettes, flash memory cards, solid state memory devices, digital versatile disks, cartridges, RAM, ROM, and hybrids thereof.

As described above, the storage device 517 can include hardware and/or software services such as service 504 that can control or configure the processor 506 to perform one or more functions including, but not limited to, the methods, processes, functions, systems, and services described herein in various examples. In some examples, the hardware or software services can be implemented as modules. As illustrated in example computing system architecture 501, the storage device 517 can be connected to other parts of the computing device 502 using the system connection 516. In some examples, a hardware service or hardware module such as service 504, that performs a function can include a software component stored in a non-transitory computer-readable medium that, in connection with the necessary hardware components, such as the processor 506, connection 516, cache 503, storage device 517, memory 505, input device 507, output device 508, and so forth, can carry out the functions such as those described herein.

The disclosed systems and service of transmitting data packets over hybrid networks (e.g., terrestrial hub 106 described herein at least in connection with FIG. 1) can be performed using a computing system such as the example computing system illustrated in FIG. 5, using one or more components of the example computing system architecture 100. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device.

In some examples, the processor 506 can be configured to carry out some or all of methods and systems for transmitting data packets over hybrid networks (e.g., terrestrial hub 106 described herein at least in connection with FIG. 1) described herein by, for example, executing code using a processor such as processor 506 wherein the code is stored in memory such as memory 505 as described herein. One or more of a user device, a provider server or system, a database system, or other such devices, services, or systems may include some or all of the components of the computing system such as the example computing system illustrated in FIG. 5, using one or more components of the example computing system architecture 501 illustrated herein. As may be contemplated, variations on such systems can be considered as within the scope of the present disclosure.

This disclosure contemplates the computer system taking any suitable physical form. As example and not by way of limitation, the computer system can be an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, a wearable computer system or interface, an interactive kiosk, a mainframe, a mesh of computer systems, a mobile telephone, a personal digital representative (PDA), a server, or a combination of two or more of these. Where appropriate, the computer system may include one or more computer systems; be unitary or distributed; span multiple locations; span multiple machines; and/or reside in a cloud computing system which may include one or more cloud components in one or more networks as described herein in association with the computing resources provider 513. Where appropriate, one or more computer systems may perform without substantial spatial or temporal limitation one or more steps of one or more methods described or illustrated herein. As an example, and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor 506 can be a conventional microprocessor such as an Intel® microprocessor, an AMD® microprocessor, a Motorola® microprocessor, or other such microprocessors. One of skill in the relevant art will recognize that the terms “machine-readable (storage) medium” or “computer-readable (storage) medium” include any type of device that is accessible by the processor.

The memory 505 can be coupled to the processor 506 by, for example, a connector such as connection 516, or a bus. As used herein, a connector or bus such as connection 516 is a communications system that transfers data between components within the computing device 502 and may, in some examples, be used to transfer data between computing devices. The connection 516 can be a data bus, a memory bus, a system bus, or other such data transfer mechanism. Examples of such connectors include, but are not limited to, an industry standard architecture (ISA” bus, an extended ISA (EISA) bus, a parallel AT attachment (PATA” bus (e.g., an integrated drive electronics (IDE) or an extended IDE (EIDE) bus), or the various types of parallel component interconnect (PCI) buses (e.g., PCI, PCIe, PCI/104, etc.).

The memory 505 can include RAM including, but not limited to, dynamic RAM (DRAM), static RAM (SRAM), synchronous dynamic RAM (SDRAM), non-volatile random-access memory (NVRAM), and other types of RAM. The DRAM may include error-correcting code (EEC). The memory can also include ROM including, but not limited to, programmable ROM (PROM), erasable and programmable ROM (EPROM), electronically erasable and programmable ROM (EEPROM), Flash Memory, masked ROM (MROM), and other types or ROM. The memory 614 can also include magnetic or optical data storage media including read-only (e.g., CD ROM and DVD ROM) or otherwise (e.g., CD or DVD). The memory can be local, remote, or distributed.

As described above, the connection 516 (or bus) can also couple the processor 506 to the storage device 517, which may include non-volatile memory or storage, and which may also include a drive unit. In some examples, the non-volatile memory or storage is a magnetic floppy or hard disk, a magnetic-optical disk, an optical disk, a ROM (e.g., a CD-ROM, DVD-ROM, EPROM, or EEPROM), a magnetic or optical card, or another form of storage for data. Some of this data may be written, by a direct memory access process, into memory during execution of software in a computer system. The non-volatile memory or storage can be local, remote, or distributed. In some examples, the non-volatile memory or storage is optional. As may be contemplated, a computing system can be created with all applicable data available in memory. A typical computer system will usually include at least one processor, memory, and a device (e.g., a bus) coupling the memory to the processor.

Software and/or data associated with software can be stored in the non-volatile memory and/or the drive unit. In some examples (e.g., for large programs) it may not be possible to store the entire program and/or data in the memory at any one time. In such examples, the program and/or data can be moved in and out of memory from, for example, an additional storage device such as storage device 517. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The connection 516 can also couple the processor 506 to a network interface device such as the network interface 509. The interface can include one or more of a modem or other such network interfaces including, but not limited to those described herein. It will be appreciated that the network interface 509 may be considered to be part of the computing device 502 or may be separate from the computing device 502. The network interface 509 can include one or more of an analog modem, Integrated Services Digital Network (ISDN) modem, cable modem, token ring interface, satellite transmission interface, or other interfaces for coupling a computer system to other computer systems. In some examples, the network interface 509 can include one or more input and/or output (I/O) devices. The I/O devices can include, by way of example but not limitation, input devices such as input device 507 and/or output devices such as output device 508. For example, the network interface 509 may include a keyboard, a mouse, a printer, a scanner, a display device, and other such components. Other examples of input devices and output devices are described herein. In some examples, a communication interface device can be implemented as a complete and separate computing device.

In operation, the computer system can be controlled by operating system software that includes a file management system, such as a disk operating system. One example of operating system software with associated file management system software is the family of Windows® operating systems and their associated file management systems. Another example of operating system software with its associated file management system software is the Linux™ operating system and its associated file management system including, but not limited to, the various types and implementations of the Linux® operating system and their associated file management systems. The file management system can be stored in the non-volatile memory and/or drive unit and can cause the processor to execute the various acts required by the operating system to input and output data and to store data in the memory, including storing files on the non-volatile memory and/or drive unit. As may be contemplated, other types of operating systems such as, for example, MacOS®, other types of UNIX® operating systems (e.g., BSD™ and descendants, Xenix™, SunOS™, HP-UX®, etc.), mobile operating systems (e.g., iOS® and variants, Chrome®, Ubuntu Touch®, watchOS®, Windows 10 Mobile®, the Blackberry® OS, etc.), and real-time operating systems (e.g., VxWorks®, QNX®, eCos®, RTLinux®, etc.) may be considered as within the scope of the present disclosure. As may be contemplated, the names of operating systems, mobile operating systems, real-time operating systems, languages, and devices, listed herein may be registered trademarks, service marks, or designs of various associated entities.

In some examples, the computing device 502 can be connected to one or more additional computing devices such as computing device 511 via a network 510 using a connection such as the network interface 509. In such examples, the computing device 511 may execute one or more services 512 to perform one or more functions under the control of, or on behalf of, programs and/or services operating on computing device 502. In some examples, a computing device such as computing device 511 may include one or more of the types of components as described in connection with computing device 502 including, but not limited to, a processor such as processor 506, a connection such as connection 516, a cache such as cache 503, a storage device such as storage device 517, memory such as memory 505, an input device such as input device 507, and an output device such as output device 508. In such examples, the computing device 511 can carry out the functions such as those described herein in connection with computing device 502. In some examples, the computing device 502 can be connected to a plurality of computing devices such as computing device 511, each of which may also be connected to a plurality of computing devices such as computing device 511. Such an example may be referred to herein as a distributed computing environment.

The network 510 can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IoT network) or any other such network or combination of networks. Communications via the network 510 can be wired connections, wireless connections, or combinations thereof. Communications via the network 510 can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), and other such communications protocols.

Communications over the network 510, within the computing device 502, within the computing device 511, or within the computing resources provider 513 can include information, which also may be referred to herein as content. The information may include text, graphics, audio, video, haptics, and/or any other information that can be provided to a user of the computing device such as the computing device 502. In some examples, the information can be delivered using a transfer protocol such as Hypertext Markup Language (HTML), Extensible Markup Language (XML), JavaScript®, Cascading Style Sheets (CSS), JavaScript® Object Notation (JSON), and other such protocols and/or structured languages. The information may first be processed by the computing device 502 and presented to a user of the computing device 502 using forms that are perceptible via sight, sound, smell, taste, touch, or other such mechanisms. In some examples, communications over the network 510 can be received and/or processed by a computing device configured as a server. Such communications can be sent and received using PHP: Hypertext Preprocessor (“PHP”), Python™, Ruby, Perl® and variants, Java®, HTML, XML, or another such server-side processing language.

In some examples, the computing device 502 and/or the computing device 511 can be connected to a computing resources provider 513 via the network 510 using a network interface such as those described herein (e.g., network interface 509). In such examples, one or more systems (e.g., service 514 and service 515) hosted within the computing resources provider 513 (also referred to herein as within “a computing resources provider environment”) may execute one or more services to perform one or more functions under the control of, or on behalf of, programs and/or services operating on computing device 502 and/or computing device 511. Systems such as service 514 and service 515 may include one or more computing devices such as those described herein to execute computer code to perform the one or more functions under the control of, or on behalf of, programs and/or services operating on computing device 502 and/or computing device 511.

For example, the computing resources provider 513 may provide a service, operating on service 514 to store data for the computing device 502 when, for example, the amount of data that the computing device 502 exceeds the capacity of storage device 517. In another example, the computing resources provider 513 may provide a service to first instantiate a virtual machine (VM) on service 515, use that VM to access the data stored on service 515, perform one or more operations on that data, and provide a result of those one or more operations to the computing device 502. Such operations (e.g., data storage and VM instantiation) may be referred to herein as operating “in the cloud,” “within a cloud computing environment,” or “within a hosted virtual machine environment,” and the computing resources provider 513 may also be referred to herein as “the cloud.” Examples of such computing resources providers include, but are not limited to Amazon® Web Services (AWS®), Microsoft’s Azure®, IBM Cloud®, Google Cloud®, Oracle Cloud® etc.

Services provided by a computing resources provider 513 include, but are not limited to, data analytics, data storage, archival storage, big data storage, virtual computing (including various scalable VM architectures), blockchain services, containers (e.g., application encapsulation), database services, development environments (including sandbox development environments), e-commerce solutions, game services, media and content management services, security services, server-less hosting, virtual reality (VR) systems, and augmented reality (AR) systems. Various techniques to facilitate such services include, but are not limited to, virtual machines, virtual storage, database services, system schedulers (e.g., hypervisors), resource management systems, various types of short-term, mid-term, long-term, and archival storage devices, etc.

As may be contemplated, the systems such as service 514 and service 515 may implement versions of various services (e.g., the service 504 or the service 512) on behalf of, or under the control of, computing device 502 and/or computing device 511. Such implemented versions of various services may involve one or more virtualization techniques so that, for example, it may appear to a user of computing device 502 that the service 504 is executing on the computing device 502 when the service is executing on, for example, service 514. As may also be contemplated, the various services operating within the computing resources provider 513 environment may be distributed among various systems within the environment as well as partially distributed onto computing device 511 and/or computing device 502.

Client devices, user devices, computer resources provider devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things such as those described herein. The input devices can include, for example, a keyboard, a mouse, a keypad, a touch interface, a microphone, a camera, and/or other types of input devices including, but not limited to, those described herein. The output devices can include, for example, a display screen, a speaker, a haptic feedback system, a printer, and/or other types of output devices including, but not limited to, those described herein. A data storage device, such as a hard drive or flash memory, can enable the computing device to temporarily or permanently store data. A network interface, such as a wireless or wired interface, can enable the computing device to communicate with a network. Examples of computing devices (e.g., the computing device 502) include, but is not limited to, desktop computers, laptop computers, server computers, hand-held computers, tablets, smart phones, personal digital representatives, digital home representatives, wearable devices, smart devices, and combinations of these and/or other such computing devices as well as machines and apparatuses in which a computing device has been incorporated and/or virtually implemented.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as that described herein. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices (e.g., a combination of a DSP and a microprocessor), a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

As used herein, the term “machine-readable media” and equivalent terms “machine-readable storage media,” “computer-readable media,” and “computer-readable storage media” refer to media that includes, but is not limited to, portable or non-portable storage devices, optical storage devices, removable or non-removable storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), solid state drives (SSD), flash memory, memory, or memory devices.

A machine-readable medium or machine-readable storage medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like. Further examples of machine-readable storage media, machine-readable media, or computer-readable (storage) media include but are not limited to recordable type media such as volatile and non-volatile memory devices, floppy and other removable disks, hard disk drives, optical disks (e.g., CDs, DVDs, etc.), among others, and transmission type media such as digital and analog communication links.

As may be contemplated, while examples herein may illustrate or refer to a machine-readable medium or machine-readable storage medium as a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

Some portions of the detailed description herein may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

It is also noted that individual implementations may be described as a process which is depicted as a flowchart, a flow diagram, a data flow diagram, a structure diagram, or a block diagram (e.g., the example method 300 of FIG. 3). Although a flowchart, a flow diagram, a data flow diagram, a structure diagram, or a block diagram may describe the operations as a sequential process, many of the operations can be performed in parallel or concurrently. In addition, the order of the operations may be re-arranged. A process illustrated in a figure is terminated when its operations are completed, but could have additional steps not included in the figure. A process may correspond to a method, a function, a procedure, a subroutine, a subprogram, etc. When a process corresponds to a function, its termination can correspond to a return of the function to the calling function or the main function.

In some examples, one or more implementations of an algorithm such as those described herein may be implemented using a machine learning or artificial intelligence algorithm. Such a machine learning or artificial intelligence algorithm may be trained using supervised, unsupervised, reinforcement, or other such training techniques. For example, a set of data may be analyzed using one of a variety of machine learning algorithms to identify correlations between different elements of the set of data without supervision and feedback (e.g., an unsupervised training technique). A machine learning data analysis algorithm may also be trained using sample or live data to identify potential correlations. Such algorithms may include k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, linear classification, artificial neural networks, anomaly detection, and such. More generally, machine learning or artificial intelligence methods may include regression analysis, dimensionality reduction, meta-learning, reinforcement learning, deep learning, and other such algorithms and/or methods. As may be contemplated, the terms “machine learning” and “artificial intelligence” are frequently used interchangeably due to the degree of overlap between these fields and many of the disclosed techniques and algorithms have similar approaches.

As an example of a supervised training technique, a set of data can be selected for training of the machine learning model to facilitate identification of correlations between members of the set of data. The machine learning model may be evaluated to determine, based on the sample inputs supplied to the machine learning model, whether the machine learning model is producing accurate correlations between members of the set of data. Based on this evaluation, the machine learning model may be modified to increase the likelihood of the machine learning model identifying the desired correlations. The machine learning model may further be dynamically trained by soliciting feedback from users of a system as to the efficacy of correlations provided by the machine learning algorithm or artificial intelligence algorithm (i.e., the supervision). The machine learning algorithm or artificial intelligence may use this feedback to improve the algorithm for generating correlations (e.g., the feedback may be used to further train the machine learning algorithm or artificial intelligence to provide more accurate correlations).

The various examples of flowcharts, flow diagrams, data flow diagrams, structure diagrams, or block diagrams discussed herein may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments) such as those described herein. A processor(s), implemented in an integrated circuit, may perform the necessary tasks.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

It should be noted, however, that the algorithms and displays presented herein are not inherently related to any particular computer or other apparatus. Various general-purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC (e.g., an iPad®, a Microsoft Surface®, a Chromebook®, etc.), a laptop computer, a set-top box (STB), a personal digital representative (PDA), a mobile device (e.g., a cellular telephone, an iPhone®, and Android® device, a Blackberry®, etc.), a wearable device, an embedded computer system, an electronic book reader, a processor, a telephone, a web appliance, a network router, switch or bridge, or any system capable of executing a set of instructions (sequential or otherwise) that specify actions to be taken by that system. The system may also be a virtual system such as a virtual version of one of the aforementioned devices that may be hosted on another computer device such as the computing device 502.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The following examples illustrate various aspects of the present disclosure. As used below, any reference to a series of examples is to be understood as a reference to each of those examples disjunctively (e.g., "Examples 1–4" is to be understood as "Examples 1, 2, 3, or 4").

Example 1 is a computer-implemented method, comprising: receiving, at a terrestrial hub, a data packet, wherein the terrestrial hub is associated with one or more locations; identifying a destination associated with the data packet, wherein the destination is identified by decapsulating the data packet; verifying that the destination associated with the data packet is a location of the one or more locations; determining a next-hop destination for the data packet based on the identified destination; encapsulating the data packet with a header comprising an address for the next-hop destination; and transmitting, by the terrestrial hub, the encapsulated packet.

Example 2 is the computer-implemented method of example 1, wherein transmitting, by the terrestrial hub, the encapsulated packet is performed via free-space optical transmission.

Example 3 is the computer-implemented method of example(s) 1–2, wherein when the encapsulated packet is received by the next-hop destination, the encapsulated packet is demodulated to extract digital data.

Example 4 is the computer-implemented method of example(s) 1–3, wherein the header comprises a shim header and the address comprises at least one of an Internet protocol (IP) address or a media access control (MAC) address.

Example 5 is the computer-implemented method of example(s) 1–4, wherein the data packet is received from a low Earth orbit (LEO) satellite optical link.

Example 6 is the computer-implemented method of example(s) 1–5, further comprising: receiving a second data packet from the next-hop destination; identifying a second destination associated with the second data packet by decapsulation; encapsulating the second data packet with a second header comprising an address for the second destination; and transmitting the encapsulated second packet to an edge device.

Example 7 is the computer-implemented method of example 6, wherein the edge device is at least one of an undersea cable associated with a communication network and a LEO satellite optical link associated with the communication network.

The above description and drawings are illustrative and are not to be construed as limiting or restricting the subject matter to the precise forms disclosed. Persons skilled in the relevant art can appreciate that many modifications and variations are possible in light of the above disclosure and may be made thereto without departing from the broader scope of the examples as set forth herein. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C}, namely: {A}, {B}, {C}, {A, B}, {A, C}, {B, C}, or {A, B, C}) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to more clearly illustrate examples and does not impose a limitation on the scope unless otherwise claimed. Such language in the specification should not be construed as indicating any non-claimed element is required for the practice of the examples described and claimed in the present disclosure.

As used herein, where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 45 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without intent to further limit the scope of the disclosure, examples of instruments, apparatus, methods, and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the examples in unnecessary detail. In other instances, well-known circuits, processes, algorithms, structures, and techniques may be shown without unnecessary detail in order to avoid obscuring the examples.

The foregoing detailed description of the technology has been presented for purposes of illustration and description. It is not intended to be exhaustive or to limit the technology to the precise form disclosed. Many modifications and variations are possible in light of the above teaching. The described examples were chosen in order to best explain the principles of the technology, its practical application, and to enable others skilled in the art to utilize the technology in various examples and with various modifications as are suited to the particular use contemplated. It is intended that the scope of the technology be defined by the claim.

What is claimed is:

1. A computer-implemented method, comprising:
receiving, at a terrestrial hub, a data packet, wherein the terrestrial hub is associated with one or more locations;
identifying a destination associated with the data packet, wherein the destination is identified by decapsulating the data packet;
verifying that the destination associated with the data packet is a location of the one or more locations;
determining a next-hop destination for the data packet based on the identified destination;
encapsulating the data packet with a header comprising an address for the next-hop destination; and
transmitting, by the terrestrial hub, the encapsulated packet.

2. The computer-implemented method of claim 1, wherein transmitting, by the terrestrial hub, the encapsulated packet is performed via free-space optical transmission.

3. The computer-implemented method of claim 1, wherein when the encapsulated packet is received by the next-hop destination, the encapsulated packet is demodulated to extract digital data.

4. The computer-implemented method of claim 1, wherein the header comprises a shim header and the address comprises at least one of an Internet protocol (IP) address or a media access control (MAC) address.

5. The computer-implemented method of claim 1, wherein the data packet is received from a low Earth orbit (LEO) satellite optical link.

6. The computer-implemented method of claim 1, further comprising:
receiving a second data packet from the next-hop destination;
identifying a second destination associated with the second data packet by decapsulation;
encapsulating the second data packet with a second header comprising an address for the second destination; and
transmitting the encapsulated second packet to an edge device.

7. The computer-implemented method of claim 6, wherein the edge device is at least one of an undersea cable associated with a communication network and a LEO satellite optical link associated with the communication network.

8. A system comprising of one or more processors and a memory storing instructions that, as a result of being executed by the one or more processors, cause the system to:
receive, at a terrestrial hub, a data packet, wherein the terrestrial hub is associated with one or more locations;
identify a destination associated with the data packet, wherein the destination is identified by decapsulating the data packet;
verify that the destination associated with the data packet is a location of the one or more locations;
determine a next-hop destination for the data packet based on the identified destination;
encapsulate the data packet with a header comprising an address for the next-hop destination; and
transmit, by the terrestrial hub, the encapsulated packet.

9. The system of claim 8, wherein transmitting, by the terrestrial hub, the encapsulated packet is performed via free-space optical transmission.

10. The system of claim 8, wherein when the encapsulated packet is received by the next-hop destination, the encapsulated packet is demodulated to extract digital data.

11. The system of claim 8, wherein the header comprises a shim header and the address comprises at least one of an Internet protocol (IP) address or a media access control (MAC) address.

12. The system of claim 8, wherein the data packet is received from a low Earth orbit (LEO) satellite optical link.

13. The system of claim 8, wherein the instructions further cause the system to:
receive a second data packet from the next-hop destination;
identify a second destination associated with the second data packet by decapsulation;
encapsulate the second data packet with a second header comprising an address for the second destination; and
transmit the encapsulated second packet to an edge device.

14. The system of claim 13, wherein the edge device is at least one of an undersea cable associated with a communication network and a LEO satellite optical link associated with the communication network.

15. A non-transitory computer-readable storage medium that stores instructions that, as a result of being executed by one or more processors, cause the one or more processors to:
receive, at a terrestrial hub, a data packet, wherein the terrestrial hub is associated with one or more locations;
identify a destination associated with the data packet, wherein the destination is identified by decapsulating the data packet;
verify that the destination associated with the data packet is a location of the one or more locations;
determine a next-hop destination for the data packet based on the identified destination;
encapsulate the data packet with a header comprising an address for the next-hop destination; and
transmit, by the terrestrial hub, the encapsulated packet.

16. The non-transitory computer-readable storage medium of claim 15, wherein transmitting, by the terrestrial hub, the encapsulated packet is performed via free-space optical transmission.

17. The non-transitory computer-readable storage medium of claim 15, wherein when the encapsulated packet is received by the next-hop destination, the encapsulated packet is demodulated to extract digital data.

18. The non-transitory computer-readable storage medium of claim 15, wherein the header comprises a shim header and the address comprises at least one of an Internet protocol (IP) address or a media access control (MAC) address.

19. The non-transitory computer-readable storage medium of claim 15, wherein the data packet is received from a low Earth orbit (LEO) satellite optical link.

20. The non-transitory computer-readable storage medium of claim 15, wherein the instructions further cause the one or more processors to:
receive a second data packet from the next-hop destination;
identify a second destination associated with the second data packet by decapsulation;
encapsulate the second data packet with a second header comprising an address for the second destination; and
transmit the encapsulated second packet to an edge device.
